(19) United States
(12) Patent Application Publication
(10) Pub. No.: US 2008/0247592 A1
(43) Pub. Date: Oct. 9, 2008

(54) Socket Assembly

(75) Inventor: Petr Kourzanov, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,078

(22) PCT Filed: Oct. 13, 2006
(86) PCT No.: PCT/IB06/53767

§ 371 Date: Apr. 22, 2008

(30) Foreign Application Priority Data
Oct. 25, 2005 (EP) 05109927.3

(51) Int. Cl. H04R 25/00

(52) U.S. Cl. 381/384

(57) ABSTRACT

The invention relates to a consumer electronics device for enabling a presentation of media content. The device comprises a housing, a control means (130) for controlling the device, and a socket (110) coupled to the housing for connecting to an output means (200) for outputting the media content, wherein the socket is adapted for a user-operable manipulation to enable the control means. Advantageously, the consumer electronics device may not require any control interface supplementary to the socket according to the present invention.

### FIELD OF THE INVENTION

The invention relates to a consumer electronics device for enabling a presentation of media content, a socket assembly for coupling to a housing of the consumer electronics device, and a system comprising the consumer electronics device and an output means for outputting the media content.

### BACKGROUND OF THE INVENTION

U.S. Pat. No. 6,845,408 discloses a portable computer system comprising a headphone jack which can conduct signals to an audio plug inserted therein. The audio plug is coupled to a peripheral device such as a headphone device or a set of audio speakers.

A mechanical switch is attached to the headphone jack. When the audio plug is inserted in the jack and physically displace a portion of the switch, the system receives an indication regarding an insertion state of the audio plug. In response, to the indication, the system may automatically pause or resume an audio playback.

The system has an alphanumeric input device comprising a touch display for enabling a user to select commands.

It is the drawback of the known portable computer system that it requires the input device such as the touch display for the control of the system. The touch display makes the known portable computer system bulky and brings additional complexity to the system.

### SUMMARY OF THE INVENTION

It is desirable to provide a consumer electronics device for enabling a presentation or media content, that is easier and simpler to control than the known system.

The consumer electronics device comprises a housing, a control means for controlling the device, and a socket coupled to the housing for connecting to an output means for outputting the media content, wherein the socket is adapted for a user-operable manipulation to enable the control means.

In addition to a function of the socket as a connector and a signal conductor between the device and a peripheral device, the socket, e.g. the well-known audio jack, is adapted to enable the user to control the device. For example, the socket is incorporated into a joystick or another lever for controlling one or more playback functions of the device. In another example, the socket is configured to be rotated and thereby to trigger a change of volume output by the peripheral device.

Advantageously, the consumer electronics device may not require any control interface supplementary to the socket according to the present invention. The device may be controlled by means of the socket, and therefore no touch screen, keypad or another control interface is necessary to control the device.

The audio jack and other kinds of the socket are familiar to the users of the consumer electronics devices and the users perceive them as an ordinary part of such devices. Therefore, the users would find it easier to use the socket to control the device than to use a completely unfamiliar control interface.

A socket assembly is also provided for coupling to a housing of a consumer electronics device for enabling a presentation of media content, the device comprising a control means for controlling the device, the socket assembly being adapted for connecting to an output means for outputting media content, wherein the socket assembly is adapted for a user-operable manipulation to enable the control means. For example, the socket assembly comprises a joystick incorporating an audio jack.

### BRIEF DESCRIPTION OF THE DRAWINGS

These and other aspects of the invention will be further explained and described, by way of example, with reference to the following drawings:

FIG. 1 is a functional block diagram of an embodiment of the system according to the present invention;

FIG. 2 is an embodiment of the socket assembly comprising a rotatable audio plug;

FIG. 3 is an embodiment of the socket assembly comprising a joystick adapted for receiving an audio plug.

For purposes of brevity and clarity, identical or corresponding components and elements of the system of the invention, will bear the same designations or numbering throughout the figures.

### DETAILED DESCRIPTION OF EMBODIMENTS

Consumer electronics (CE) devices, especially portable CE devices, often comprise one or more audio or video connectors. The connectors are used to connect cables or other signal conductors to the CE devices, providing electronic signal transference and grounding protection. The connectors may be plugs, jacks or other combinations. A plug type connector is a plug, or male, connector that may include one or more pins that can be inserted into a socket. A jack type connector is a jack, or female, connector that may consist of a socket aligned to mesh with one or more pins of the plug connector. The connector may be used to connect the CE device with the cable attached to, e.g. a telephone or a microphone.

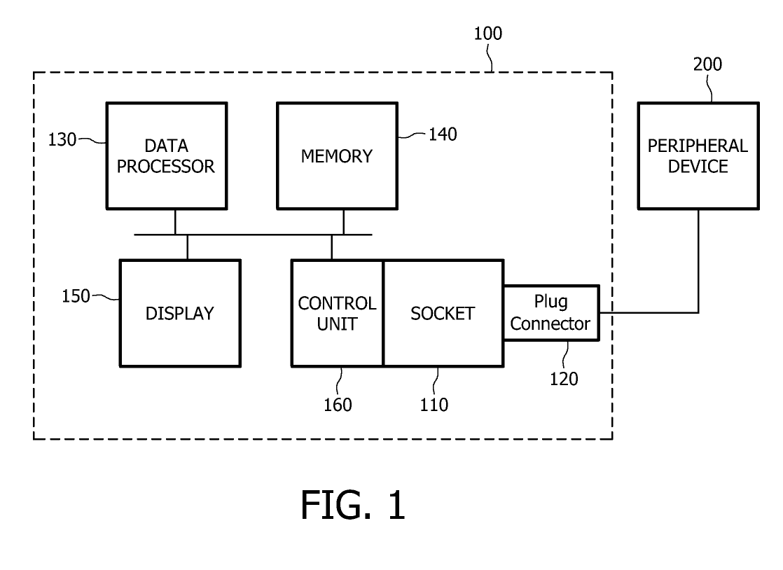

FIG. 1 shows an embodiment of a system comprising the (CE) device 100 and an output means 200 (peripheral device, e.g. the telephone or the microphone). The device 100 may be connected to the peripheral device via the socket 110, the plug connector 120 and the cable or another conductor. The plug connector and the socket may be of any type, e.g. RCA (Radio Corporation of America) or S-Video (“S”—“separate”).

The device 100 may comprise a data processor 130, a memory 140, an optional display 150, a control unit 160, the socket 110 and a communication bus for enabling the communication between the elements of the device 100. For example, the device 100 is a portable music player.

The memory 140 may be adapted to store media content on a data carrier such as an optical storage disc, e.g., a CD-ROM disc (Compact Disc Read Only Memory) or a DVD disc (Digital Versatile Disc), floppy and hard-drive disk, etc., in any format, e.g., MPEG (Motion Picture Experts Group), MIDI (Musical Instrument Digital Interface), Shockwave, QuickTime, WAV (Waveform Audio), etc. The memory 140 may comprise a computer hard disk drive, a versatile flash memory card, e.g., a “Memory Stick” device, etc. The media content may comprise at least one of, or any combination of, visual information (e.g., video images, photos, graphics), audio information and other digital data.

The data processor 130 may be a well-known central processing unit (CPU) suitably adapted to enable the operation of the device 100. In the portable music player, the data processor may be configured to receive a user command, select media content on the basis of the user command, and initiate an output of the selected media content to the peripheral device 200 via the control unit 160, the socket 110 and the plug connector 120.

The data processor 130 may be configured to control an output of information, e.g. a title of a selected song or video content item, via the display 150 to a user. The display may be any conventional means for presenting video information to the user, for example, a CRT (cathode ray tube), LCD (Liquid Crystal Display), LCOS (Liquid Crystal on Silicon) rear-projection technology, DLP (Digital Light Processing) television/Projector, Plasma Screen display device, etc.

The control unit 160 and the socket 110 are preferably combined in a socket assembly. The socket is adapted to be manipulated by the user. Basically, the user may move the socket to achieve a desired control on the device 100. The movement may comprise a rotation, pressing, pulling, or shifting right/left or forward/backward. The manipulation of the socket may be performed when the plug connector is inserted in the socket. In that case, the user may grip a plug connector end projecting from the socket and force the socket attached to the plug connector to change its position. Alternatively, the socket may comprise e.g. a gripping element, e.g. a protrusion, which the user may grip to manipulate the socket even if the plug connector is not inserted in the socket. The control unit 160 may be adapted to supply one or more user commands to the data processor 130 in response to the manipulation of the socket assembly.

Two examples of the socket assembly are described in the proceeding sections; however, these should not be assumed to be the only possible implementations.

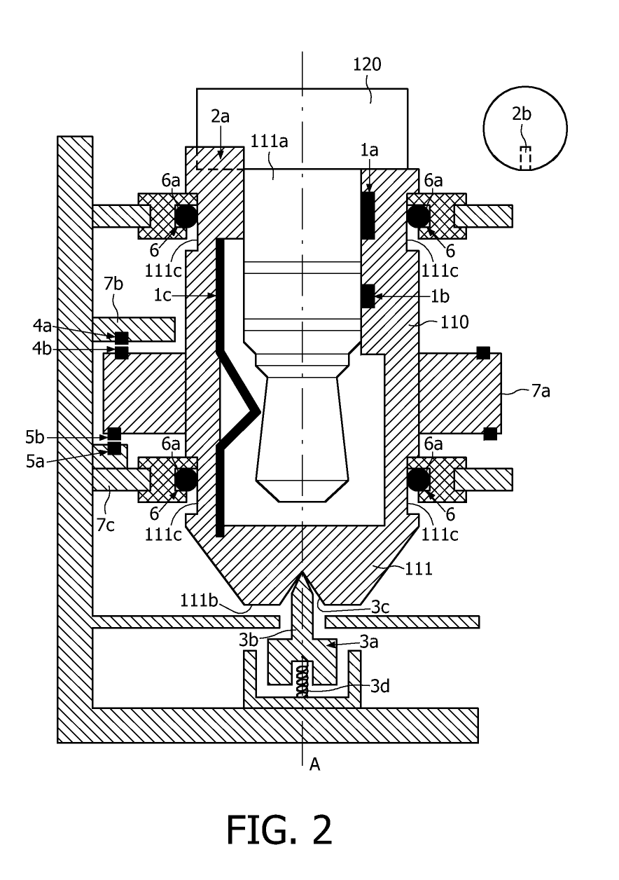

FIG. 2 shows an embodiment of the socket assembly comprising the jack 110 for mounting in the housing of the device, and an embodiment of the plug connector 120 (shown not stippled).

The jack 110 includes an insulative body 111 and conductive first, second and third contact members 1a, 1b, 1c mounted on the inner face of the insulative body 111. The contact members 1a, 1b and 1c may be arranged to contact respective signal pick-up surfaces of the plug connector 120. Audio and/or video signals may be thereby transmitted from the device 100 to the peripheral device 200 via the socket 110 and the plug connector 120.

The insulative body 111 has a plug insertion hole 111a that extends along a central axis (A) from an open end to a closed end 111b of the body 111. The plug connector 120 is shown as inserted into the jack to the maximum.

The insulative body is rotatable around the central axis (A).

The closed end 111b of the body 111 may be supported e.g. by a thrust block 3a including a bearing portion 3b for engaging with e.g. a conical concavity 3c formed in the body 111 at the closed end 111b. The thrust block may also comprise an urging means, e.g. a spring 3d, for elastically fitting the bearing portion 3b to the concavity 3c.

The body 111 may extend between bearings 6 attached to the housing of the device 100. Central holes of the bearings 6 have bearing concavities 6a on their inner face. Concavities 111c are formed in the body 111 that face the bearing concavities 6a so that the body 111 is movable along the central axis (A) (e.g. the bearing concavities 6a are longer than the concavities 111c as shown in FIG. 2). Metal balls may be disposed between the concavities 111c and 6a.

The body 111 may have a disk 7a for rotating together with jack 110. In one embodiment, an extension 7b is provided in the housing so that the disk 7a may rotate close to the extension 7b. One or more detectors 4b are provided along a circumference of one side of the disk 7a, and one or more detectors 4a may be arranged on the extension 7b to cooperate with the detectors 4b. Preferably, a small passage remains between the disk 7a with the detectors 4b and the extension 7b so that the rotation of the jack 110 is not hampered. The detectors 4a and 4b are components of the control unit for supplying a user command signal to the data processor 130. The detectors 4a and 4b may be of any type and construction, e.g. photo sensors and reflective elements, or a variable resistance pattern, suitable for a conversion by the control unit of the rotation of the body 111 into the corresponding user command signal for adjusting the volume.

In another embodiment, one or more detectors 5a and 5b are provided on (one side of) the disk 7a and an extension 7c respectively. The extension 7c may be arranged in the housing in the vicinity of the disk 7a so that the cooperation between the detectors 5a and 5b is possible. The bearings 6 may be made from an elastic material so that the body 111 is displaceable between one of the bearings 6 like a mini joystick (lever). The detectors 5a and 5b may be adapted to detect when the user inclines the body in one of directions. For example, depending on the direction, one of the detectors 5a and a respective one of the detectors 5b may contact each other, e.g. to establish an electric closed circuit and thereby the control unit may generate a corresponding user command signal. The control unit may be adapted to generate a user command signal corresponding to an activation of the respective detectors 5a and 5b upon the manipulation of the body 111 by the user. For example, the detectors 5a and 5b are suitable to measure a force applied by disk 7a on the extension 7c caused by the shear of the body 111 at the open end from the central axis (A). The user command signal may be processed by the data processor 130 to control the playback of the media content. For instance, the data processor may translate the force applied to the jack in a first or second direction (e.g. left/right) into a volume change command or a rewind forward/backward command.

In one embodiment, the body 111 is provided at the open end with a projection 2a for engaging with a notch 2b on the plug connector 120 when the plug connector 120 is inserted in the jack 110. Alternatively, the plug connector may be provided with the projection 2a and the body may be provided with the notch 2b. This measure ensures that the plug connector does not slide when the user uses the plug connector to rotate the body 111. Optionally, the jack 110 has such dimensions of the plug insertion hole 111a that the rotation of the plug connector 120 is impossible if the plug connector does not have any means for engaging with the body 111.

In one example, the socket assembly is provided with means for locking the body 111 to prevent its rotation e.g. as long is the body 111 is not pressed towards the thrust block 3a. For example, the disk 7a is provided with an extension member (not shown) that couples to a groove (not shown) in the extension 7b or 7c.

In another example, the jack 110 is adapted to receive the plug connector 120 only when the jack is in a position for setting a minimal volume. For example, the jack 110 may be adapted to automatically turn in the (starting) minimal volume position after the plug connector 120 is extracted from the jack. This may be realized with a suitable rewinding mechanism with resilient means. The insertion of the plug connector into the jack in the minimal volume position may be insured by a ring fixed to the housing of the device 100. The ring may have a groove aligned with the notch in the body 111 for engaging with the projection of the plug connector when the jack is in the minimal volume position. The projection should first pass via the groove to arrive into the notch.

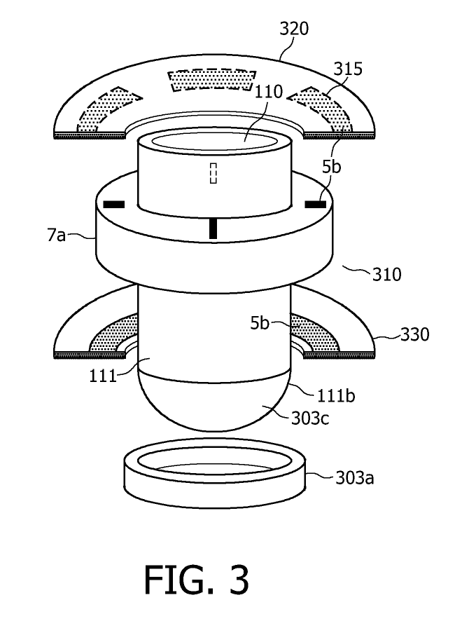

FIG. 3 shows an embodiment of the socket assembly comprising the socket 110 incorporated into the joystick 310. Instead of the joystick, any other suitable manipulator of the lever type may also be used. The joystick itself may be implemented in the known manner. For example, the joystick 310 may comprise the body 111 and the disk 7a with the detectors 5b e.g. on two sides. The disk 7a may be arranged between two plates 320 and 330 with the holes allowing to place the plates on the body 111 in parallel to the disk 7a. The surface of the plate 320 and/or 330 which faces the disk 7a may be provided with the detectors 5b like in FIG. 2. The detectors 5b may be formed e.g. as sectors 315 of metal layers on the plates 320 and/or 330. The detectors 5b may be metal strips. When the body 111 is inclined sideward, one of the metal strips may contact one of the sectors so that e.g. an electric circuit is closed and the corresponding user command signal is generated. Alternatively, the detectors 5b and the sectors 315 are pressure sensors for sensing a pressure exerted by the manipulation of the jack. A suitable support mechanism may be provided to support the body 111 at one end 111b, e.g. by means of a support ring 303a for cooperation with a spherical surface formed at the end 111b, while the body is movable at another end where the plug connector is inserted into the body 111. The body 111 may be configured inside as the socket 110 shown in FIG. 2 and it may have the plug insertion hole 111a.

Each of the detectors 5b may be associated with a corresponding user command signal. The control unit may be configured to generate the user command signal depending on the position of the jack in which a specific one of the detectors registered the movement of the jack. Similarly as in the embodiment of FIG. 2, the data processor 130 may translate the manipulation of the jack in a first or second direction (e.g. left/right) into a volume change command or a rewind forward/backward command. The mapping between the positions of the socket 110 and the user commands for controlling the device 100 may be predetermined and stored in the memory 140. Alternatively, the data processor may be configured to enable the user to specify the desired mapping and store it in the memory 140.

Variations and modifications of the described embodiment are possible within the scope of the inventive concept. For example, the plug connector shown in FIG. 2 may comprise one or more pins for picking up signals from the suitably adapted socket. In this case, no special projection 2a and the notch 2b are required to ensure a robust manipulation of the socket using the plug connector.

The device 100 may be any of various consumer electronics devices such as a portable DVD player, a portable CD player, a cell phone, etc.

The various program products may implement the functions of the data processor 130 and may be combined in several ways with the hardware or located in one or more devices. Parts of the invention can be implemented by means of hardware comprising several distinct elements, and by means of a suitably programmed computer. In the device claim enumerating several means, several of these means can be embodied by one and the same item of hardware.

1. A consumer electronics device (100) for enabling a presentation of media content, the device comprising a housing, a control means (130) for controlling the device, and a socket (110) coupled to the housing for connecting to an output means (200) for outputting the media content, wherein the socket is adapted for a user-operable manipulation to enable the control means.

2. The device of claim 1, wherein the socket is an audio jack for receiving a jack plug (120) for connecting to a headphone.

3. The device of claim 1, wherein the socket is adapted for a rotation to enable a volume control.

4. The device of claim 3, wherein the socket is adapted for enabling the volume control only when the socket is depressed or pulled by a user.

5. The device of claim 2, wherein the audio jack is adapted to receive the jack plug only when the audio jack is in a position for setting a minimal volume.

6. The device of claim 1, wherein the socket is adapted to be manipulated as a lever in at least one predetermined position associated with a respective control command produced by the control means.

7. A socket assembly (110, 111, 6, 7a) for coupling to a housing of a consumer electronics device (100) for enabling a presentation of media content, the device comprising a control means (130) for controlling the device, the socket assembly being adapted for connecting to an output means (200) for outputting media content, wherein the socket assembly is adapted for a user-operable manipulation to enable the control means.

8. A system comprising a consumer electronics device (100) for enabling a presentation of media content and an output means (200) for outputting the media content, the device comprising a housing, a control means (130) for controlling the device, and a socket (110) coupled to the housing for connecting to the output means, wherein the socket is adapted for a user-operable manipulation to enable the control means.
